(19) United States
(12) Patent Application Publication
(10) Pub. No.: US 2010/0276893 A1
(43) Pub. Date: Nov. 4, 2010

(54) Dynamic Sealing System

(76) Inventors: Gordon F. Jewess, San Diego, CA (US); Eric A. Alexander, San Diego, CA (US); Stephen George Mican, West Point, CA (US)

Correspondence Address: STEPHEN GEORGE MICAN, Post Office Box 803338, #8973, Chicago, IL, 60680-3338, US

(21) Appl. No.: 12/433,496

(22) Filed: Apr. 30, 2009

(51) Int. Cl. F16J 15/40

(52) U.S. Cl. 277/424

(57) ABSTRACT

A dynamic sealing assembly for a rotating shaft to seal an forward portion of the shaft from an aft portion of the shaft, comprises: a stationary member that has an aperture with a spiral grooved aperture surface that passes through it to receive the shaft; and generally linear shaft surface undulations between the forward and aft portions of the shaft that are at least partially within the sealing member aperture; wherein rotation of the shaft causes the undulations to propagate fluid from between the rotating shaft and the aperture into the grooved aperture surface back toward the forward portion of the shaft.

### GOVERNMENT RIGHTS STATEMENT

The development of this invention involved government support under N00024-C-04-6301 awarded by the United States Navy. The government has certain rights in the invention.

### FIELD OF THE INVENTION

The invention relates to high speed rotational machinery, and more particularly to lubrication sealing systems for rotational components of such machinery.

### BACKGROUND OF THE INVENTION

High speed rotational machinery, such as turbo-machinery, employs rotating shafts with associated bearings. In most applications a closed circuit, recirculating lubrication oil system delivers oil to the shafts and bearings within sealed cavities. Such a sealed cavity requires a shaft seal for any shaft that extends from it to prevent lubrication oil seepage.

Miniature gas turbine or turbojet engines as used in expendable unmanned aeronautical vehicles (UAVs) often use such recirculating lubrication oil systems. Because such an UAV is expendable, manufacturing cost is an important consideration. Shaft seals that have sufficient reliability, efficiency and durability for such applications are generally very expensive. Furthermore, they generally comprise rubber or carbon sealing elements that may suffer degradation in long term storage.

### SUMMARY OF THE INVENTION

The invention generally comprises a dynamic sealing assembly for a rotating shaft to seal an forward portion of the shaft from an aft portion of the shaft, comprising: a stationary member that has an aperture with a spiral grooved aperture surface that passes through it to receive the shaft; and generally linear shaft surface undulations between the forward and aft portions of the shaft that are at least partially within the sealing member aperture; wherein rotation of the shaft causes the undulations to propagate fluid from between the rotating shaft and the aperture into the grooved aperture surface back toward the forward portion of the shaft.

### DESCRIPTION OF THE DRAWINGS

FIG. 1 is a side view of a dynamic sealing assembly 2 according to a possible embodiment of the invention.

FIG. 2 is a side view of a rotatable shaft for the dynamic sealing assembly shown in FIG. 1.

FIG. 3 is a cut-away end view of a knurled portion of the shaft shown in FIG. 2.

FIG. 4 is a side view of a stationary member for the dynamic sealing assembly shown in FIG. 1.

FIG. 5 is a cut-away side view of the stationary member shown in FIG. 4.

### DETAILED DESCRIPTION OF THE INVENTION

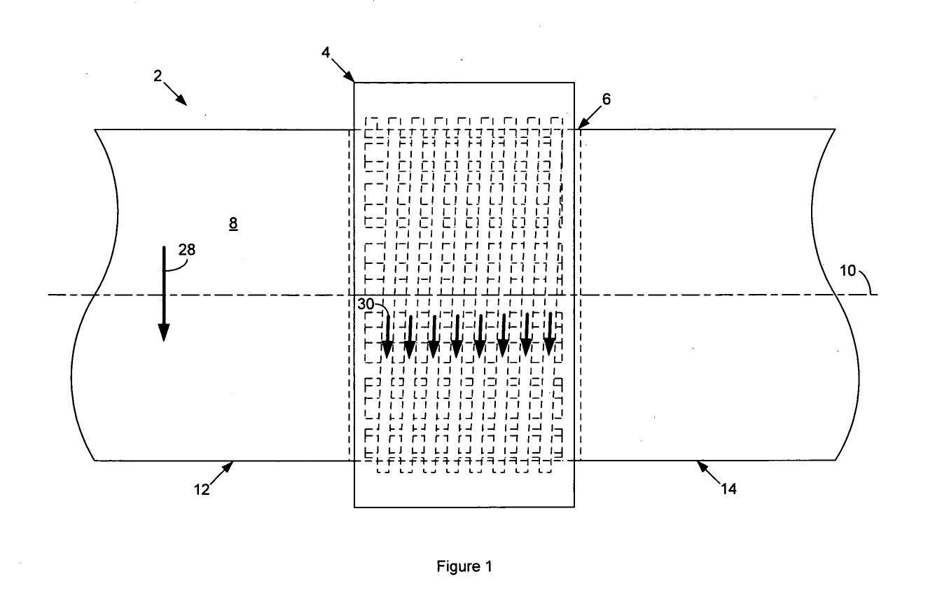

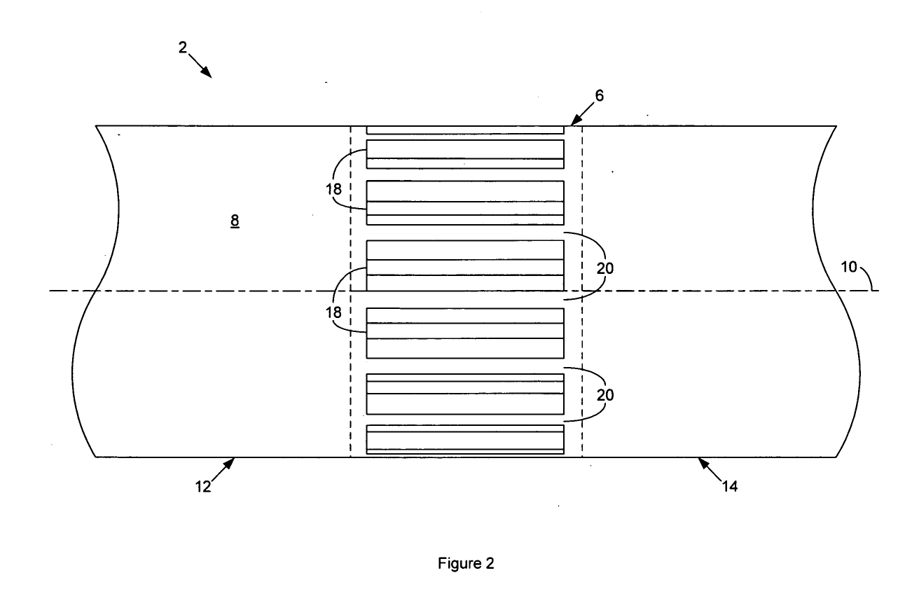

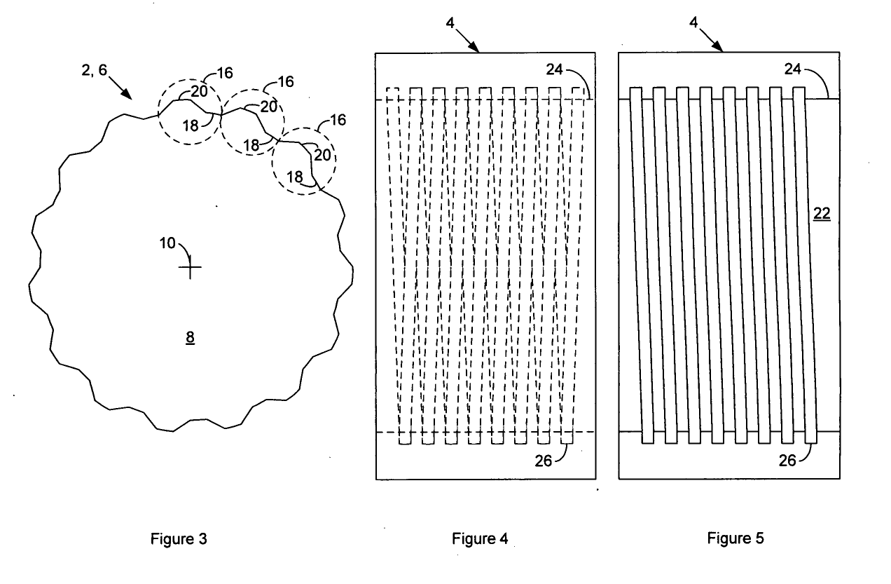

FIG. 1 is a side view of a dynamic sealing assembly 2 according to a possible embodiment of the invention. The sealing assembly 2 comprises a stationary member 4 and a knurled portion 6 of a shaft 8 that is rotatable about a shaft axis 10. FIG. 2 is a side view of the shaft 8 shown in FIG. 1 and FIG. 3 is a cut-away end view of the knurled portion 6 of the shaft 2 shown in FIG. 2. Referring to FIG. 2, the knurled portion 6 of the shaft 8 is between a forward portion 12 and an aft portion 14 of the shaft 8. Referring to FIGS. 2 and 3 together, the knurled portion 6 comprises generally linear shaft surface undulations 16 within the knurled portion 6 of the shaft 8.

Each surface undulation may comprise generally linear grooves 18 that penetrate the surface of the knurled portion 6 and lands 20 there between the grooves 18. Although FIGS. 2 and 3 show the undulations 16 as generally diamond-shaped knurls, they may have almost any convenient profile. Formation of the grooves 18 may be by any convenient process, such as by crimping, stamping, grinding or ablation. Alternatively, the undulations 16 may comprise generally linear projections above the surface of the knurled portion 6 and lands there between the projections.

FIG. 4 is a side view of the stationary member 4 for sealing assembly 2 shown in FIG. 1 and FIG. 5 is a cut-away side view of the stationary member 4 shown in FIG. 4. Referring to FIGS. 4 and 5 together, the stationary member 4 has an aperture 22 with a spiral grooved aperture surface 24 that receives the shaft 8 and envelops at least part of the knurled portion 6 of the shaft 8. The spiral grooved aperture surface 24 may have a single spiral groove 26, as shown in FIGS. 4 and 5, in which case the aperture 22 may conveniently comprise a threaded hole, or the aperture surface 24 may comprise multiple generally parallel spiral grooves 26.

Referring to FIG. 1, rotation of the shaft 8 about its axis 10 in the direction indicated by rotation arrow 28 causes the undulations 18 in the knurled portion 6 of the shaft 8 to propagate fluid in the interface between the knurled portion 6 of the shaft 8 and the aperture 22 of the stationary member 4 into the grooved surface 24 of the stationary member and through the spiral groove 26 back toward the forward portion 12 of the shaft 8, as represented by fluid flow arrows 30. This may then prevent any fluid in the interface between the knurled portion 6 of the shaft 8 and the aperture 22 of the stationary member 4 from reaching the aft portion 14 of the shaft 8, so long as the shaft 8 is rotating, making the sealing assembly 2 an ideal inexpensive dynamic sealing apparatus for recirculating lubrication oil systems in UAVs. Preferably, the undulations 16 are generally perpendicular to the path of the spiral groove 26 for highest reverse fluid flow toward the forward portion 12 of the shaft 8, but it may be desirable to select a different angle to achieve a different rate of reverse fluid flow for a given speed of the shaft 8 in certain applications.

The sealing assembly 2 may have many other applications with many types of fluids as well. Furthermore, the stationary member 4 may serve as a sleeve bearing to support the shaft 8 as well as to seal the forward portion 12 of the shaft 8 from the aft portion 14 of the shaft 8, in which case the sealing assembly 2 eliminates the need for an external shaft support bearing by serving as a combination bearing and dynamic sealing assembly. The described embodiments of the invention are only some illustrative implementations of the invention wherein changes and substitutions of the various parts and arrangement thereof are within the scope of the invention as set forth in the attached claims.

1. A dynamic sealing assembly for a rotating shaft to seal a forward portion of the shaft from an aft portion of the shaft, comprising:
a stationary member that has an aperture with a spiral grooved aperture surface that passes through it to receive the shaft; and
generally linear shaft surface undulations between the forward and aft portions of the shaft that are at least partially within the sealing member aperture;
wherein rotation of the shaft causes the undulations to propagate fluid from between the rotating shaft and the aperture into the grooved aperture surface back toward the forward portion of the shaft.

2. The sealing assembly of claim 1, wherein the undulations extend along the shaft generally perpendicular to the spiral groove path.

3. The sealing assembly of claim 1, wherein the undulations comprise generally linear grooves in the shaft surface and lands there between.

4. The sealing assembly of claim 1, wherein the undulations comprise generally linear projections above the shaft surface and lands there between.

5. The sealing assembly of claim 1, wherein the aperture surface has a single spiral groove.

6. The sealing assembly of claim 5, wherein the aperture in the stationary sealing member comprises a threaded hole that receives the shaft.

7. The sealing assembly of claim 1, wherein the aperture surface has multiple generally parallel spiral grooves.

8. A dynamic sealing assembly for a rotating shaft to seal a forward portion of the shaft from an aft portion of the shaft, comprising:
a stationary member that has an aperture with a spiral grooved aperture surface that passes through it to receive the shaft; and
generally linear shaft surface undulations between the forward and aft portions of the shaft that are at least partially within the sealing member aperture and generally perpendicular to the spiral groove path;
wherein rotation of the shaft causes the undulations to propagate fluid from between the rotating shaft and the aperture into the grooved aperture surface back toward the forward portion of the shaft.

9. The sealing assembly of claim 8, wherein the undulations comprise generally linear grooves in the shaft surface and lands there between.

10. The sealing assembly of claim 8, wherein the undulations comprise generally linear projections above the shaft surface and lands there between.

11. The sealing assembly of claim 8, wherein the aperture surface has a single spiral groove.

12. The sealing assembly of claim 11, wherein the aperture in the stationary sealing member comprises a threaded hole that receives the shaft.

13. The sealing assembly of claim 8, wherein the aperture surface has multiple generally parallel spiral grooves.

14. A bearing and dynamic sealing assembly for a rotating shaft to support the shaft and seal a forward portion of the shaft from an aft portion of the shaft, comprising:
a stationary member that has a spiral grooved aperture surface that passes through it to receive and support the shaft; and
generally linear shaft surface undulations between the forward and aft portions of the shaft that are at least partially within the sealing member;
wherein rotation of the shaft causes the undulations to propagate fluid from between the rotating shaft and the aperture into the sealing member hole thread back toward the forward portion of the shaft.

15. The bearing and sealing assembly of claim 14, wherein the undulations extend along the shaft generally perpendicular to the spiral groove path.

16. The bearing and sealing assembly of claim 14, wherein the undulations comprise generally linear grooves in the shaft surface and lands there between.

17. The bearing and sealing assembly of claim 14, wherein the undulations comprise generally linear projections above the shaft surface and lands there between.

18. The bearing and sealing assembly of claim 14, wherein the aperture surface has a single spiral groove.

19. The bearing and sealing assembly of claim 18, wherein the aperture in the stationary sealing member comprises a threaded hole that receives the shaft.

20. The bearing and sealing assembly of claim 14, wherein the aperture surface has multiple generally parallel spiral grooves.
